(19) United States
(12) Patent Application Publication
(10) Pub. No.: US 2006/0172780 A1
(43) Pub. Date: Aug. 3, 2006

(54) Vehicle audio system capable of playing wireless audio data received from a mobile audio player

(76) Inventor: Thomas Krippgans, Ulm (DE)

Correspondence Address: BRINKS HOFER GILSON & LIONE, P.O. BOX 10395, CHICAGO, IL, 60610, US

(21) Appl. No.: 11/266,140

(22) Filed: Nov. 2, 2005

(30) Foreign Application Priority Data
Nov. 2, 2004 (EP) 04 025 957.4

(51) Int. Cl. H04M 1/00

(52) U.S. Cl. 455/569.2

(57) ABSTRACT

An audio system for use in a vehicle is set forth. The audio system comprises one or more loudspeakers of the vehicle and a receiver operating to receive digital data in first and second digital audio data formats. The first digital audio data format corresponds to a format used by a mobile audio device to wirelessly transmit digital audio stored on the mobile audio device. The second digital audio data format corresponds to a wireless audio data transmission format that differs from the first digital audio data format. The receiver may operate in multiple routing modes. In a first routing mode, the receiver responds to the receipt of digital data in the first digital audio data format by routing the digital data through the audio system for ultimate output as analog audio at the loudspeakers. The receiver operates in a second routing mode in response to receiving digital data in the second digital audio data format to route digital data in the second digital audio data format through the system for ultimate output as analog audio at the loudspeakers. The receiver may automatically switch between the first routing mode and the second routing mode based on whether digital data received by the receiver is in the first or second digital audio data format. Further, the audio system may be configured so that the second routing mode has priority over the first routing mode with respect to ultimate output at the loudspeakers. In one example, the first digital audio format is a Bluetooth audio format while the second digital audio format comprises a Bluetooth hands-free communications format.

### BACKGROUND OF THE INVENTION

1. Priority Claim

This application claims the benefit of priority from European Patent Application No. 04025957.4, filed Nov. 2, 2004, which is incorporated by reference.

2. Technical Field

The present invention relates to providing wirelessly transmitted audio data from a mobile audio device to a vehicle audio system.

3. Related Art

Vehicle audio systems have attempted to integrate audio from a range of disparate sources. For example, some vehicle audio systems incorporate hands-free telephone technology. Hands-free telephones provide a comfortable and safe communication system for use in motor vehicles. Some in-vehicle, hands-free telephone systems may employ a remote headset that is wirelessly connected to the hands-free telephone system in the head unit of the vehicle via a short-range radio transceiver link. The short-range transceivers may use Time Division Multiple Access as the communication protocol between the headset and the head unit.

Consumer electronic hardware has become smaller and more efficient in recent years. For example, small memory chips and miniaturization techniques allow for packing of electronic devices in smaller spatial dimensions. Thus, mobile audio devices such as cassette recorders, Compact Disc (“CD”) players, Digital Video Disc (“DVD”) players, MP3/WAV/WMA players are commonly available and have become targets for integration with the audio system of a vehicle.

While integration of a mobile audio device with the vehicle's audio system may be desirable, simple and low-cost realization are currently less than adequate. For example, some systems rely on FM modulation of the baseband audio signal received from the mobile audio device. To this end, the actual audio signal from a baseband audio signal output of the mobile device is connected to the input of an FM modulator. The FM modulator transmits the audio from the mobile device at a predetermined frequency in the commercial FM band. The automobile operator tunes the FM receiver of the vehicle's audio system to the predetermined frequency in order to receive the transmitted audio.

Wireless FM transmission of the baseband audio signal may suffer from many deficiencies. For example, the fidelity of the audio ultimately provided at the output of the FM receiver may be substandard since it is highly dependent on the quality of the FM modulator as well as the nature of the RF environment of the vehicle. The original fidelity associated with the digital audio data used to store the audio on the mobile audio device is compromised. Further, reception of a quality FM signal may be difficult in populated areas having a large number of commercial FM stations.

As an alternative to using wireless FM connections to integrate a mobile audio device with the vehicle's audio system, some integration solutions have focused on hardware docking stations and the like that accommodate the mobile audio device. Hardware docking solutions, however, may be inconvenient and costly due to the demand for constructional modifications. Further, some hardware docking solutions may limit the ability of the user to change the types of mobile devices that are integrated into the vehicle's audio system. Changes may require additional constructional modifications of the system.

### SUMMARY

An audio system for use in a vehicle is set forth. The audio system comprises one or more loudspeakers disposed in the passenger compartment of the vehicle and a receiver operating to receive digital data in first and second digital audio data formats. The first digital audio data format corresponds to a format used by a mobile audio device to wirelessly transmit digital audio stored on the mobile audio device. The second digital audio data format comprises a wireless transmission format that differs from the first digital audio data format. The receiver may operate in multiple routing modes. In a first routing mode, the receiver responds to the receipt of digital data in the first digital audio data format by routing the digital data through the audio system for ultimate output as analog audio at the loudspeakers. The receiver operates in a second routing mode in response to receiving digital data in the second digital audio data format to route digital data in the second digital audio data format through the system for ultimate output as analog audio at the loudspeakers. The receiver may automatically switch between the first routing mode and the second routing mode based on whether digital data received by the receiver is in the first or second digital audio data format. Further, the audio system may be configured so that the second routing mode has priority over the first routing mode with respect to ultimate output at the loudspeakers. In one example, the first digital audio format is a Bluetooth audio format while the second digital audio format comprises a Bluetooth hands-free communications format.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic block diagram of one example of a system that may be used to provide audio corresponding to wireless digital audio data transmitted by a mobile audio device to the output of a vehicle audio system.

FIG. 2 is a schematic block diagram of a further example of a system that may be used to provide audio corresponding to wireless digital audio data transmitted by a mobile audio device to the output of a vehicle audio system.

FIG. 3 is a schematic block diagram of a further example of a system that may be used to provide audio corresponding to wireless digital audio data transmitted by a mobile audio device to the output of a vehicle audio system.

FIG. 4 is a schematic block diagram of a further example of a system that may be used to provide audio corresponding to wireless digital audio data transmitted by a mobile audio device to the output of a vehicle audio system.

FIG. 5 is a flow chart showing a number of interrelated processes that may be used to wirelessly transmit digital audio data to the output of a vehicle audio system.

### DETAILED DESCRIPTION

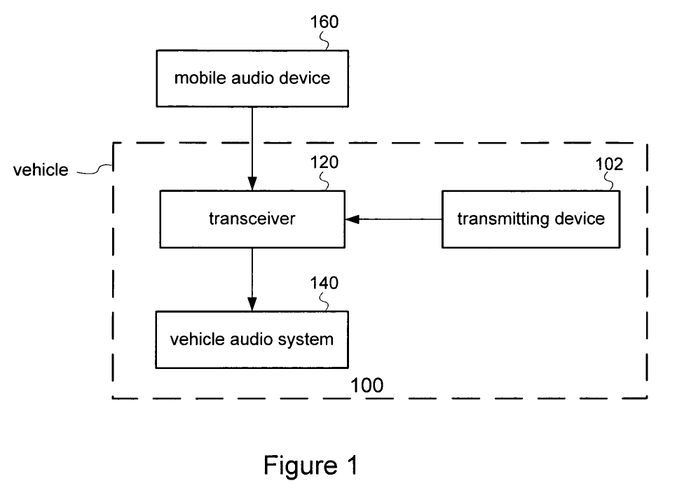

FIG. 1 is a schematic block diagram of one example of a system that may be used to provide audio corresponding to wireless digital audio data transmitted by a mobile audio device to the output of a vehicle audio system. The system, shown generally at 100, may comprise a transmitting device 105, a transceiver 120, a mobile audio device 160, and a vehicle audio system 140.

The vehicle audio system 140 may comprise more audio components. For example, system 140 may comprise an internal vehicle radio, a CD player, and MP3 player, as well as amplifier and loudspeaker components. Additional components, or a reduced subset of the foregoing components, also may be employed.

Transceiver 120 operates to communicate with various apparati in the vehicle using different communication formats. In the example, transceiver 120 may receive digital audio data from mobile audio device 160 using a first digital audio data format and digital audio data from transmitting device 105 using a second digital audio data format that is different from the first format. Transceiver 120 may operate in a first routing mode so that audio corresponding to data transmitted from mobile audio device 160 in the first digital audio data format is provided for ultimate output as audio at the loudspeakers of the vehicle audio system 140. Similarly, transceiver 120 may operate in a second routing mode so that audio corresponding to data transmitted from transmitting device 105 in the second digital audio data of format is provided for ultimate output as audio at the loudspeakers of the vehicle audio system 140.

The routing mode used by the transceiver 120 may be determined by a number of different factors. For example, a user may manually select whether the transceiver 120 is in the first or second routing modes through, for example, one or more switches, a general user interface, or the like. Alternatively, or in addition, the transceiver 120 may automatically enter a particular routing mode depending on the format of the digital audio data that is received. The routing modes may be prioritized in the latter instance so that the second routing mode has priority over the first routing mode. For example, audio corresponding to the second digital audio data format may be provided for output on system 140 whenever transceiver 120 concurrently receives digital audio data from both the mobile audio device 160 and transmitting device 105.

The mobile audio device 160 may be an MP3 player, CD player, portable satellite radio, or other digital media player. Transmitting device 105, on the other hand, may be a wireless headset, mobile phone, or the like. In each instance, the format used to transmit audio data may differ between the devices 105 and 160.

Various communication protocols may be used to transmit digital audio data from the mobile audio device 160 and transmitting device 105, respectively, to the transceiver 120. Suitable communication protocols/technologies include Bluetooth technology, infrared technology, wireless local area network (WLAN) technology, and the like. If the mobile audio device 160 uses Bluetooth technology, the wirelessly transmitted audio data may be formatted according to the Bluetooth audio profile. If the transmitting device 105 uses Bluetooth technology, the transmitting device 100 may format the audio data according to the Bluetooth hands-free profile or the Bluetooth headset profile.

Bluetooth represents a short-distance (less than 10 meters) wireless communication technique that is increasingly prevalent. Bluetooth is relatively low in both cost and power consumption, which makes it suitable for mobile devices. When different systems operate in conformity with the Bluetooth standard, they may be operationally linked together, even if they are produced by different manufacturers. Specifically, Bluetooth technology makes use of the ISM band (2,402-2,480 GHz) that is globally available and license-free. The employed fast frequency hopping method with 1600 frequency changes per second guarantees a relatively high interference resistance.

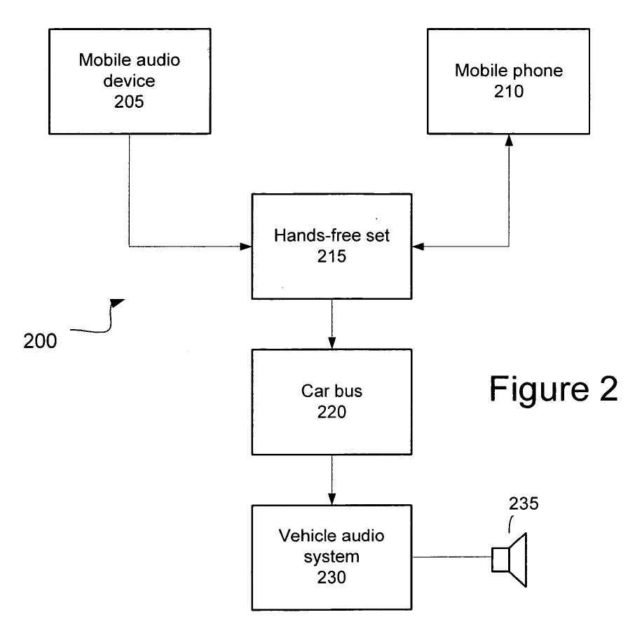

FIG. 2 is a schematic block diagram of a further exemplary system that may be used to provide audio corresponding to wireless digital audio data transmitted by a mobile audio device to the output of a vehicle audio system. In this system, shown generally at 200, the vehicle is equipped with an audio system 230 and loudspeakers 235 as well as with a hands-free set 215. The hands-free set 215 may be connected via a Bluetooth link to a mobile phone 210. The hands-free set 215 may also be connected to the audio system 230 via car bus 220. Communications between the mobile phone 210 and the hands-free set 215 may be established using the Bluetooth hands-free communications format.

System 200 receives digital audio data transmitted from mobile audio device 205 using the Bluetooth audio format. The digital audio data received by the hands-free set 215 from device 205 may be converted to analog audio and routed to the audio system 230 for playback through speakers 235. Thus, a user can listen to music or other audio programming stored in device 205 through audio system 230.

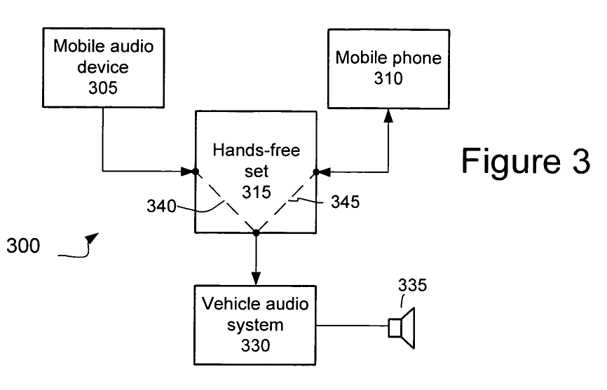

FIG. 3 is a schematic block diagram of system 300 that operates in a manner similar to the systems shown in FIGS. 1 and 2. In system 300, a mobile audio device 305 transmits audio data as radio signals formatted according to the Bluetooth format to a hands-free set 315 installed in the vehicle. The hands-free set 315 comprises a switch to selectively route digital audio data transmitted by the mobile audio device 305 or by a mobile phone 310 to a vehicle audio system 330. When the switch is in the state shown at position 340, a user may listen to music or other audio programming stored in device 305 through the vehicle audio system 330. Similarly, when the switches in the state shown at position 345, the user may use mobile phone 310 in a hands-free mode of operation. In this latter position, the verbal utterances of a remote party are transmitted to the hands-free set 315 for provision to the driver through vehicle audio system 330, and the verbal utterances of the driver are transmitted to the mobile phone 310 using the hands-free set 315.

System 300 also may include a headset that is connected via Bluetooth with the mobile phone 310. Communications between the headset and the mobile phone 310 may take place using the Bluetooth headset format. When a headset is employed, the utterances of the user are detected by the microphones of the headset rather than by the microphones of the hands-free set 315. The radio signals conveying the utterances of the remote party may be provided through the headset or the vehicle audio system 330.

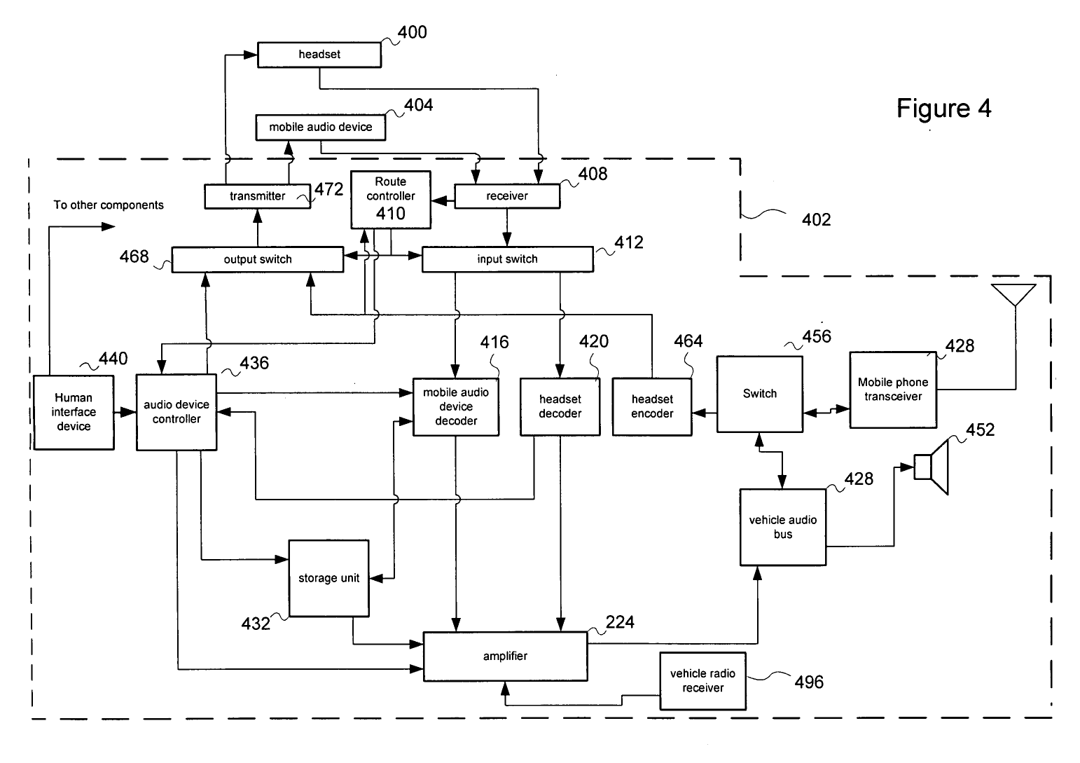

FIG. 4 is schematic block diagram of a further exemplary system that may be used to provide audio corresponding to wireless digital audio data transmitted by a mobile audio device to the output of a vehicle audio system. In the system of FIG. 4, a mobile audio device 404 and mobile phone headset 400 constitute the peripheral components that are used to wirelessly transmit digital audio data to system 402 for ultimate output at one or more loudspeakers 452.

As shown, system 402 may include a transceiver that includes a transmitter section and a receiver section. The receiver section may include a receiver 408 that is capable of receiving digital audio data in at least two different data formats. One format corresponds to a digital audio format transmitted by headset 400 and another format corresponds to a digital audio format transmitted by mobile audio device 404. Receiver 408 may demodulate the received signal and provide a baseband digital audio signal at its output. The baseband digital audio output signal may be provided to the input of switch 412.

Route controller 410 may be connected to receiver 408 and used to identify which digital audio data formats are received by the receiver 408. Depending on which digital audio data formats are identified, route controller 410 may automatically direct input switch 412 to provide the received digital audio data to either a headset decoder 420 or a mobile audio device decoder 416. The baseband digital audio signal from receiver 408 is provided to the mobile audio device decoder 416 when the route controller 410 identifies reception of digital audio data corresponding to the format transmitted by mobile audio device 404. Similarly, the baseband digital audio signal from receiver 408 is provided to the headset decoder 416 when the route controller 410 identifies reception of digital audio data corresponding to the format transmitted by headset device 400.

When a given decoder 416 or 420 receives the baseband digital audio signal from switch 412, the decoder generates a corresponding audio signal at its output. In system 402, the audio signals are provided to the input of an audio amplifier 424 which, in turn, places the amplified audio signal on the vehicle's audio bus 428. One or more speakers normal 452 are connected to the bus 428 and provide the audio to the passenger cabin of the vehicle.

There may be instances in which route controller 410 identifies the reception of more than one digital audio format at receiver 408. In these situations, route controller 410 may respond to user commands provided through human interface device 440 to determine which decoder is used to decode the baseband digital audio data. Since the digital audio data formats of the headset 400 and mobile audio device 404 are different, only one of the digital audio data streams will be decoded to audio and provided on the audio bus 428. Alternatively, or in addition, route controller 410 may prioritize decoding of one received data stream over another. For example, route controller 410 may direct switch 412 to provide the baseband digital audio from receiver 408 to headset decoder 420 anytime headset 400 sends a digital audio transmission. As a result, system 402 will suppress audio from mobile audio device 404 anytime the headset 400 is used to make or receive a call using, for example, mobile phone transceiver 428.

The transmitter section of system 402 may include a transmitter 472 that is capable of transmitting data in at least two different data formats. One format may correspond to the digital audio format received by headset 400 and another format may correspond to the data format used by mobile audio device 404 to receive operating commands. Route controller 410 and output switch 468 cooperate with one another to determine whether the system 402 transmits digital audio data to the headset 400 or digital commands to the mobile audio device 404.

Digital data corresponding to commands that are to be executed by mobile audio device 404 may originate in audio device controller 436. For example, a user may initiate the transmission of a command through manipulation of one or more switches of human interface device 440. Audio device controller 436, in turn, provides a baseband digital signal to the input of switch 468. The route controller 410 places the switch 468 into a state for forwarding digital commands to the mobile audio device 404, and the baseband digital command signal is provided to the input of transmitter 472, which modulates the baseband digital signal at its input for provision to mobile audio device 404.

Transmission of digital audio data to headset 400 may originate with baseband audio provided by mobile phone transceiver 428 to switch 456. The switch 456 is used to direct whether the audio from the transceiver 428 is provided on audio bus 428 for output on loudspeakers 452, or to the input of headset encoder 464. Switch 456 may be placed under the control of the route controller 410. When switch 456 provides the audio to headset encoder 464, headset encoder 464 converts the analog audio signal that it receives into a baseband digital audio signal. This baseband digital audio signal, in turn, is provided through output switch 468 to the input of transmitter 472. The digital audio transmission is then received at headset 400, which converts the digital audio signal to a baseband audio signal that can be heard by the user. As above, transmissions for headset 400 may be given priority over transmissions to mobile audio device 204.

System 402 may also include a storage unit 432. Storage unit 432 is connected to selectively receive the output of the mobile audio device encoder under the direction of the audio device controller 436. When system 402 has been configured to communicate with headset 400, route controller 410 may indicate this fact to audio device controller 436. Controller 436, in turn, directs decoder 416 and storage unit 432 to cooperate with one another to store digital audio data received from mobile audio device 404 in unit 432 while the system 402 is used to concurrently communicate with headset 400. Once communications with headset are completed, the user may direct system 402 to playback the stored audio by issuing the proper commands through interface 440.

The system in FIG. 4 may also be configured to automatically reduce the volume output of audio if vehicle radio receiver 496 receives a predetermined class of broadcast data from a broadcast source. Classes of broadcast data received by vehicle radio receiver 496 may include information on traffic conditions or news programs. In one example, reducing or muting the output volume of the audio data may occur concurrent with or before a news program or traffic condition becomes available. Vehicle radio receiver 496 may receive a predetermined class of broadcast data and route a corresponding control signal to amplifier 424 to reduce the volume output of the audio data. Additionally, the system may automatically reduce the volume output of audio depending on whether the audio originates at headset 400 or mobile audio device 402.

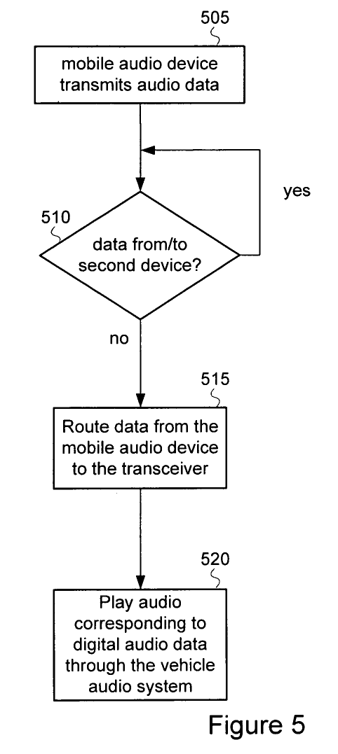

FIG. 5 is a flow chart showing a number of interrelated processing steps that may be used to transmit wireless digital audio data for output by a vehicle audio system. The exemplary process employs a transceiver, a mobile audio device that is capable of transmitting digital audio data to the transceiver, a second transmitting device that is capable of transmitting audio data to the transceiver in a format that differs from the data transmitted by the mobile audio device, and a vehicle audio system. The second transmitting device may be a mobile phone and the transceiver may be a vehicle hands-free system for the mobile phone.

At step 505, the mobile audio device may wirelessly transmit audio data, such as music, in an audio format, such as the Bluetooth audio format. A check is made at step 510 to determine whether the second transmitting device is actively communicating with the transceiver. If the second transmitting device and the transceiver are communicating with each other at step 510, the audio data transmitted by the mobile audio device is ignored by the system and/or not otherwise routed to the vehicle audio system. Alternatively, the system may receive the audio data transmitted by the mobile audio device and store this audio data in a storage device. The stored audio data may then be replayed after the communication between the second transmitting device and the transceiver has terminated.

If the check at step 510 determines that the second transmitting device is not actively communicating with the transceiver, the audio data transmitted by the mobile audio device may be routed to the transceiver at step 510. Audio corresponding to the digital audio data received from the mobile audio device is ultimately played through the vehicle audio system at step 520.

The systems illustrated in FIGS. 1 through 4 may be configured using corresponding programming stored on a data storage device, such as a CD, DVD, hard disc drive, a floppy disk, or the like. Similarly, the process illustrated in FIG. 5 may be incorporated in a program stored on such a data storage device.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. An audio system for use in a vehicle comprising:
one or more loudspeakers disposed in the vehicle;
a receiver operating to receive digital data in first and second digital audio data formats, the first digital audio data format corresponding to a format used by a mobile audio device to wirelessly transmit digital audio stored on the mobile audio device, the second digital audio data format differing from the first digital audio data format;
where the receiver operates in a first routing mode in response to receiving digital data in the first digital audio data format to route digital data in the first digital audio data format for ultimate output as audio at the one or more loudspeakers; and
where the receiver operates in a second routing mode in response to receiving digital data in the second digital audio data format to route digital data in the second digital audio data format for ultimate output as audio at the one or more loudspeakers.

2. The audio system of claim 1 where the second routing mode has priority over the first routing mode with respect to ultimate output at the one or more loudspeakers.

3. The audio system of claim 2 and further comprising a storage device, the receiver routing digital data in the first digital audio data format, if present, to the storage device when the receiver is in the second routing mode.

4. The audio system of claim 1 where the receiver automatically switches between the first routing mode and the second routing mode based on whether digital data received by the receiver is in the first or second digital audio data format.

5. The audio system of claim 1 where the second digital audio data format comprises a digital audio data format used to communicate with a component of a hands-free vehicle phone system.

6. The audio system of claim 1 where the second digital audio format comprises a Bluetooth hands-free communications format.

7. The audio system of claim 6 where the first digital audio format comprises a Bluetooth audio format.

8. A system for use in a vehicle comprising:
a mobile audio device capable of wirelessly transmitting digital audio data in a first digital audio data format;
a communication device capable of wirelessly transmitting digital audio data in a second digital audio data format that is different from the first digital audio data format;
a vehicle audio system fixed within the vehicle;
a transceiver disposed in the vehicle and operating to receive digital audio data in the first and second digital audio data formats, the transceiver cooperating with the vehicle audio system to provide audio corresponding to the first digital audio data format through the vehicle audio system when digital audio data in the first digital audio format is received.

9. The system according to claim 8 where the first digital audio format comprises a format selected from the group consisting of Bluetooth technology, Wireless Local Area Network technology, and infrared technology.

10. The system according to claim 8 where the communication device is a mobile phone.

11. The system according to claim 8 where the transceiver is directed by a user to receive the digital audio data transmitted by the mobile audio device.

12. The system according to claim 8 where the transceiver cooperates with the vehicle audio system to provide audio corresponding to the second digital audio data format through the vehicle audio system when digital audio data in the second digital audio format is received while preventing output of audio corresponding to concurrently transmitted digital audio data in the first digital audio data format.

13. The system according to claim 8 and further comprising a storage unit, where the storage unit operates to store the digital audio data transmitted by the mobile audio device.

14. The system according to claim 8 and further comprising a storage unit, where the storage unit operates to store the digital audio data transmitted by the mobile audio device whenever the transceiver is receiving digital audio data in the second digital audio data format.

15. The system according to claim 13 where the storage unit is manually operated to store the audio data transmitted by the mobile audio device.

16. The system according to claim 13 where the storage unit stores the digital audio data transmitted by the mobile audio device when the transceiver communicates with a mobile phone using the second digital audio data format.

17. The system according to claim 13 where the vehicle audio system outputs audio corresponding to the digital audio data transmitted by the mobile audio device at a reduced volume in response to a predetermined condition.

18. A method for operating a vehicle audio system comprising:
locally receiving wirelessly transmitted digital audio data in a first digital audio format from a mobile audio device and in a second digital audio format from a further audio transmitter, and
automatically routing digital audio data received in either the first or second digital audio data formats for output of corresponding audio through one or more speakers of the vehicle audio system in response to a predetermined condition.

19. The method according to claim 18 where the wirelessly transmitted audio data is transmitted using a wireless technologies selected from the group consisting of Bluetooth technology, Wireless Local Area Network technology, and infrared technology.

20. The method according to claim 18 where receiving the wirelessly transmitted audio data is initiated by a user.

21. The method according to claim 18 where the predetermined condition comprises whether the received digital audio data is in the first or second digital audio data formats, and where routing of digital audio data in the second digital audio format is prioritized for corresponding audio output through the one or more speakers over digital audio data in the first digital audio format.

22. The method according to claim 18 further comprising storing the wirelessly transmitted audio data received by the transceiver in a storage device.
